(19) United States
(12) Patent Application Publication
(10) Pub. No.: US 2008/0017008 A1
(43) Pub. Date: Jan. 24, 2008

(54) Band Saw Blade Guide Wear Pad

(76) Inventors: Clayton Brenton, Nanaimo (CA); Denis Cousineau, Parksville (CA)

Correspondence Address: BROOKS KUSHMAN P.C., 1000 TOWN CENTER, TWENTY-SECOND FLOOR, SOUTHFIELD, MI, 48075, US

(21) Appl. No.: 11/571,443

(22) PCT Filed: Jun. 30, 2005
(86) PCT No.: PCT/CA05/01036

§ 371 Date: Dec. 29, 2006

(30) Foreign Application Priority Data
Jul. 2, 2004 (CA) 2474984

(51) Int. Cl. B27B 13/12

(52) U.S. Cl. 83/820

(57) ABSTRACT

A band saw blade guide wear pad includes a slab having a first contact face of wear resistant material, a second contact face of wear resistant material opposed to the first contact face, and a peripheral edge. When the wear resistant material on the first contact face becomes worn, the slab is inverted and use of the slab continues until the wear resistant material on the second contact face also becomes worn. Variations of wear pad holders adapted for use with the wear pads are also described.

### FIELD OF THE INVENTION

The present invention relates to an innovative band saw guide wear pad and a holder which is adapted to hold the wear pad.

### BACKGROUND OF THE INVENTION

Band saw blade guides have a long history dating back to the 1800's. Historically, band saw blade guide wear pads have had a front contact face and a rear mounting face. The rear mounting face of the wear pad is used to secure the wear pad to a holder. The front contact face of the wear pad is brought into contact with and serves to guide the band saw blade.

One of the most popular band saw blade guides is one marketed by Norpac Equipment sales Limited of Langley, British Columbia, under the Trade Mark NORGUIDE. The NORGUIDE system is illustrated and described in U.S. Pat. No. 4,231,274 entitled “Saw Guide Assembly” (Matchette from 1980) and U.S. Pat. No. 4,317,400 entitled “Saw Guide Clamping Assembly” (Matchette from 1982). The reason the NORGUIDE system has achieved popularity, is that the wear pads can be re-machined. In fact, the NORGUIDE system is sold with the necessary jigs and equipment to permit accurate re-machining of the wear pads. One disadvantage inherent in the NORGUIDE system is the labour cost and downtime involved with frequent re-machining and repositioning of the band saw guides in preparation for use after each re-machining. Another disadvantage inherent in the NORGUIDE system is the rising expense of the wear pads, and unavoidable waste of wear pad material through re-machining.

### SUMMARY OF THE INVENTION

The present invention relates to a band saw blade guide wear pad which represents a paradigm shift in thinking.

According to the present invention there is provided a band saw blade guide wear pad which includes a slab having a first contact face of wear resistant material, a second contact face of wear resistant material opposed to the first contact face, and a peripheral edge. When the wear resistant material on the first contact face becomes worn, the slab is inverted and use of the slab continues until the wear resistant material on the second contact face also becomes worn.

With the wear pad, as described above, represents an advance over the prior art for a number of reasons. Firstly, the wear pad can be inverted when the first contact face is worn, so that double the wear can be obtained. Secondly, when the wear pad is inverted, there is no need to reposition the band saw blade guide as there is with re-machining. The operator can maintain a constant band saw blade guide positioning and save valuable set up time. Thirdly, small less expensive wear pads can be used. The wear pads are inverted once and then disposed of.

Although beneficial results may be obtained through the use of the wear pads, as described above, some work has been done to determine how the cost of the wear pads can be further reduced. It has been determined that even more beneficial results may be obtained when the slab has a rigid centrally positioned supporting core layer, sandwiched between two layers of wear resistant material. This enables thinner layers of wear resistant material to be used. The layers of wear resistant material do not have to be self support, because they gain support from the core layer. A further benefit is obtained from the use of a core layer. As long as there is a difference in colouration, the operator is given a visual cue to invert the wear pad should the core layer become visible.

Once the inventive concept of the wear pads is understood, persons skilled in the art will have no difficulty in developing suitable holders. It is not possible to describe every holder configuration. Two variations of holder will hereinafter be illustrated and described.

It is envisaged that the wear pads can be readily adapted for use with all existing equipment. This can be done by merely placing an adaptor engagement on the holder for the wear pads. For example, the NORGUIDE system uses a dovetail engagement to hold its re-machinable wear pads. The NORGUIDE system can readily be adapted for use with the wear pads described herein, by placing a dovetail engagement on the holder to adapt the holder for use with the NORGUIDE system.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of the band saw blade wear pad constructed in accordance with the teachings of the present invention.

FIG. 2 is a perspective view of an alternative band saw blade wear pad constructed in accordance with the teachings of the present invention

FIG. 3 is a perspective view of the band saw blade wear pad of FIG. 1 placed against a band saw blade.

FIG. 4 is an end elevation view of the band saw blade wear pad of FIG. 1 placed against a band saw blade.

FIG. 5 is a perspective view of the band saw blade wear pad of FIG. 1 and a holder.

FIG. 6 is a perspective view of the band saw blade wear pad of FIG. 1 engaged with a holder.

FIG. 7 is an end elevation view of an alternative band saw blade wear pad constructed in accordance with the teachings of the present invention

FIG. 8 is a perspective view of the band saw blade wear pad of FIG. 7 and a holder.

FIG. 9 is a perspective view of the band saw blade wear pad of FIG. 7 engaged with a holder.

### DETAILED DESCRIPTION OF THE PREFERRED EMBODIMENT

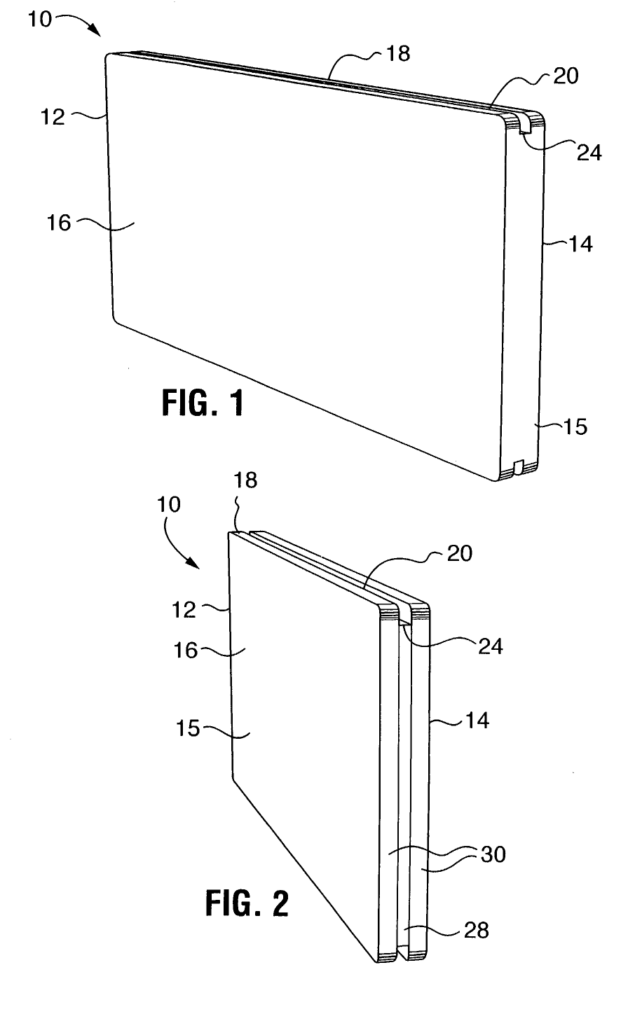

The preferred embodiment, a band saw blade wear pad generally identified by reference numeral 10, will now be described with reference to FIGS. 1 through 9.

Structure and Relationship of Parts:

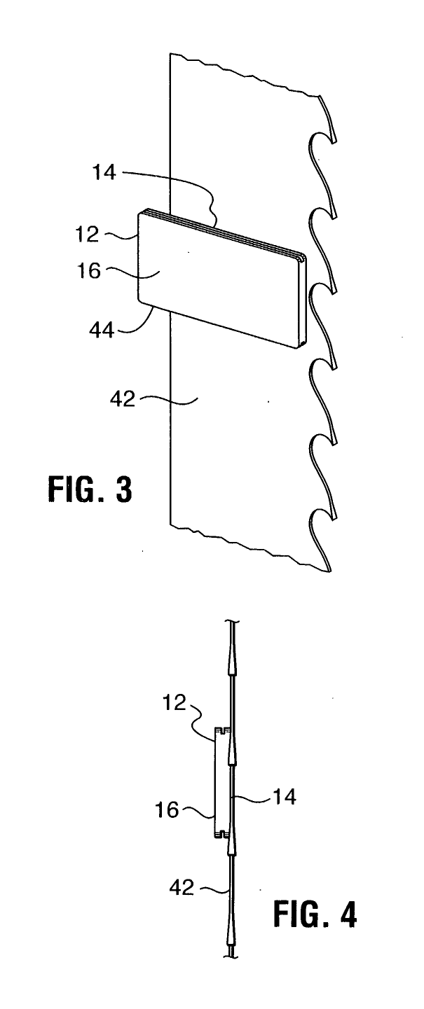

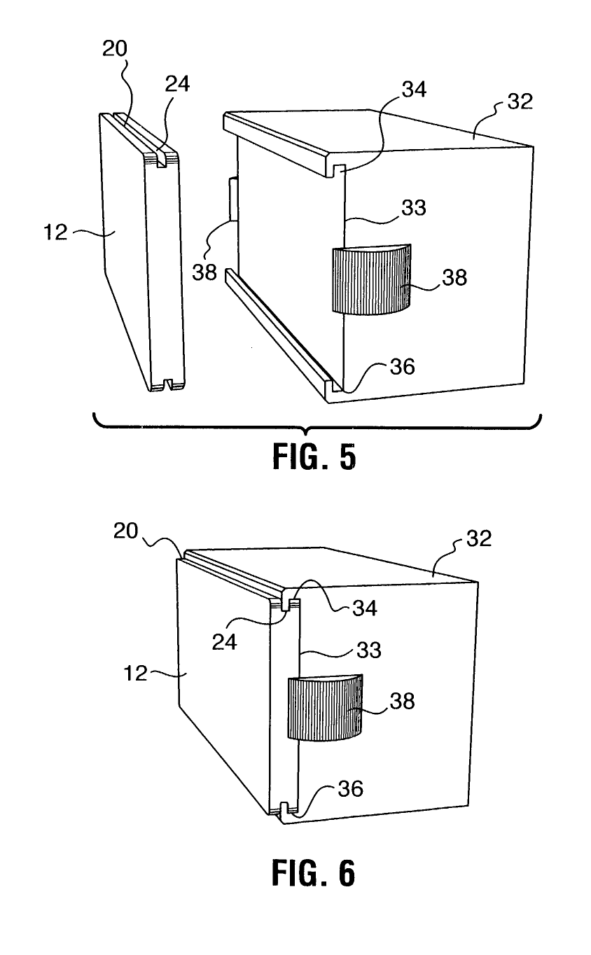

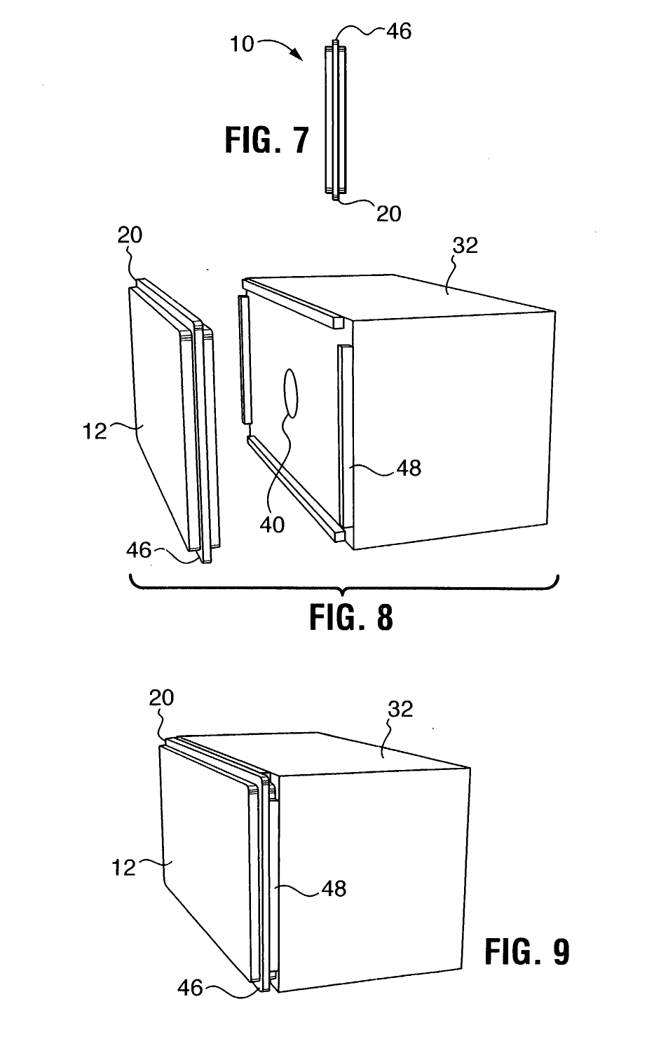

Referring now to FIG. 1, there is shown band saw blade guide wear pad 10, comprising a slab 12 having a first contact face 14 of wear resistant material 15 and a second contact face 16 of wear resistant material 15 opposed to first contact face 14. There is also a peripheral edge 18. When wear resistant material 15 on first contact face 14 becomes worn, slab 12 is inverted and use of slab 12 continues until wear resistant material 15 on second contact face 16 also becomes worn. Referring to FIGS. 3 and 4, slab 12 is placed with first contact face close to a band saw blade 42 to guide it. There is a slight overhang 44 shown off the back of slab 12. Referring to FIG. 6, peripheral edge 18 has engagement means 20 adapted to engage a holder 22. Referring to FIG. 5, engagement means 20 includes grooves 24. Referring to FIG. 7, engagement means 20 may alternatively include a protruding engagement 46 that protrudes from peripheral edge 18 of slab 12. Referring to FIG. 2, slab 12 may have a rigid centrally positioned supporting core layer 28 sandwiched between two layers 30 of wear resistant material 15. Core layer 28 may be made of a material which is attracted by a magnet 40, as will hereinafter be described in relation to FIG. 8. Core layer 28 may be made visually distinct from wear resistant material 15. This provides a visual indication to an operator to invert wear pad 10, when wear resistant material 15 has been worn to the point that core layer 28 has become visible.

Referring to FIG. 5, there is a holder 32 that has an engagement track 33 adapted to engage engagement means 20 along peripheral edge 18 of slab 12 as shown in FIG. 6. Referring again to FIG. 5, holder 32 has an upper guide rail 34 and a lower guide rail 36. Grooves 24 along peripheral edge 18 of slab 12 are adapted to engage upper guide rail 34 and lower guide rail 36 are. Holder 32 may, optionally, have stops 38 adapted to confine slab 12 and prevent movement of slab 12 along upper guide rail 34 and lower guide rail 36 of holder 32. Alternatively or additionally, referring to FIG. 7, if core layer 28 is made of a material which is attracted by a magnet, holder 32 may have a magnet 40 adapted to magnetically hold core layer 28 of slab 12 to holder 32 as shown in FIG. 8

Referring to FIG. 7, engagement means 20 may be a peripheral flange 46 on core layer 28 that protrudes from peripheral edge 18 of slab 12. On holder 32, peripheral rails 48 may be provided on holder 32 which are adapted to engage peripheral flange 46. This arrangement works best when magnet 40 is included to magnetically hold core layer 28. The position of slab 12 may then be accurately maintained using magnet 40 and rails 48.

Operation:

The use and operation of band saw blade wear pad 10 will now be discussed with reference to FIGS. 1 through 9. Referring to FIG. 1, the key aspect of the present invention is that when wear resistant material 15 on first contact face 14 becomes worn, slab 12 is inverted and use of slab 12 continues until wear resistant material 15 on second contact face 16 also becomes worn. The actual means of holding slab 12 in position is of secondary importance.

Referring now to FIG. 1 and 2, in this illustrated embodiment band saw blade wear pad 10 is provided with engagement means 20 in the form of a groove 24, and with or without core layer 28. Referring to FIGS. 5 and 6, engagement means 20 of slab 12 engages engagement track 33 of holder 32, with upper guide rail 34 and lower guide rail 36 engaging grooves 24. Stops 38 prevents slab 12 from moving.

An alternative embodiment of band saw blade wear pad 10, as shown in FIG. 7, has engagement means 20 in the form of a peripheral flange 46 that protrudes from peripheral edge 18. In this embodiment, core layer 28 is made from a material which is attracted by a magnet. Referring to FIGS. 8 and 9, magnet 40 in holder 32 attracts core layer 28, and peripheral rails 48 engage peripheral flange 46 to hold slab 12 in position.

Referring now to FIGS. 3 and 4, where holder 32 is not shown for simplicity's sake, slab 12 is positioned with first contact face 14 against band saw blade 42 with a slight overhang 44. Once first contact face 14 is worn, indicated to the operator by the core layer 28 becoming visible, slab 12 is removed, and flipped over in holder 32 such that second contact face 16 is positioned against band saw blade 42. As is know to persons skilled in the art, if desired, slab 12 may be rotated such that overhang 44 of first contact face 14, which was formerly not in contact with band saw blade 42 is placed in contact with band saw blade 42. Using this strategy, there are four usable surfaces that may be worn on each band saw blade wear pad 10.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A band saw blade guide wear pad, comprising:
a slab having a first contact face of wear resistant material, a second contact face of wear resistant material opposed to the first contact face, and a peripheral edge, such that when the wear resistant material on the first contact face becomes worn, the slab is inverted and use of the slab continues until the wear resistant material on the second contact face also becomes worn.

2. The band saw blade guide wear pad as defined in claim 1, wherein the slab has a rigid centrally positioned supporting core layer, sandwiched between two layers of wear resistant material.

3. The band saw blade guide wear pad as defined in claim 1, wherein the peripheral edge has engagement means adapted to engage a holder.

4. The band saw blade guide wear pad as defined in claim 3, wherein the engagement means includes at least one groove.

5. The band saw blade guide wear pad as defined in claim 3, wherein the engagement means includes at least one protruding engagement protruding from the peripheral edge of the slab.

6. The band saw blade guide wear pad as defined in claim 2, wherein the core layer is made of a material which is attracted by a magnet.

7. The band saw blade guide wear pad as defined in claim 2, wherein the core layer is visually distinct from the wear resistant material, thereby providing a visual indication when the wear resistant material has been worn to the point that the core layer has become visible.

8. In combination:
a band saw blade guide wear pad as defined in claim 1;
engagement means along the peripheral edge of the stab; and
a holder having an engagement track adapted to engage the engagement means along the peripheral edge of the slab.

9. The combination as defined in claim 8, wherein the slab has a rigid centrally positioned supporting core layer, sandwiched between two layers of wear resistant material.

10. The combination as defined in claim 8, wherein the holder has an upper guide rail and a lower guide rail, and the engagement means are grooves along the peripheral edge of the slab which are adapted to engage the upper guide rail and the lower guide rail.

11. The combination as defined in claim 10, wherein the holder has stops adapted to confine the slab and prevent movement of the slab along the upper guide rail and the lower guide rail of the holder.

12. The combination as defined in claim 9, wherein the core layer is visually distinct from the wear resistant material, thereby providing a visual indication when the wear resistant material has been worn to the point that the core layer has become visible.

13. In combination:
a band saw blade guide wear pad in the form of a slab having a first contact face of wear resistant material, a second contact face of wear resistant material opposed to the first contact face, and a peripheral edge, such that when the wear resistant material on the first contact face becomes worn, the slab is inverted and use of the slab continues until the wear resistant material on the second contact face also becomes worn;
the slab having a rigid centrally positioned supporting core layer made of a material which is attracted by a magnet, sandwiched between two layers of wear resistant material.
a holder having a magnet adapted to magnetically hold the core layer of the slab to the holder.

14. The combination as defined in claim 13, wherein engagement means on the core layer protrude from the peripheral edge of the slab and peripheral rails are provided on the holder which adapted to engage the protruding engagement means on the core layer and thereby maintain accurate positioning of the slab relative to the holder.

15. The combination as defined in claim 14, wherein the engagement means is a peripheral flange.

16. The combination as defined in claim 13, wherein the core layer is visually distinct from the wear resistant material, thereby providing a visual indication when the wear resistant material has been worn to the point that the core layer has become visible.
